(19) United States
(12) Patent Application Publication
(10) Pub. No.: US 2018/0305968 A1
(43) Pub. Date: Oct. 25, 2018

(54) POWERED GARAGE DOOR OPENER

(71) Applicant: Magna Closures Inc., Newmarket (CA)

(72) Inventors: James J. FERRI, Maple (CA); Jeffrey Richard F. DOMENCHINI, Etobicoke (CA); Luciano BOIN, Richmond Hill (CA)

(21) Appl. No.: 15/949,152

(22) Filed: Apr. 10, 2018

Related U.S. Application Data
(60) Provisional application No. 62/489,685, filed on Apr. 25, 2017.

(51) Int. Cl. E05F 15/686; F16H 19/06; F16H 57/039; F16H 57/035; F16D 1/10

(52) U.S. Cl. CPC E05F 15/686; F16H 19/06; F16H 57/039; F16H 57/035; F16D 1/10; F16H 1/16; E05Y 2201/654; E05Y 2201/702; E05Y 2201/71; E05Y 2900/106; E05Y 2201/434

(57) ABSTRACT

A powered garage door opener is provided for mounting to a garage wall adjacent to the garage door in a side-mounted configuration. The powered garage door opener includes a power unit containing an electric motor, a reduction gearset driven by the electric motor, and a tubular output member driven by the reduction gearset. The output member defines a pass-thru aperture configured to drivingly couple to a coupler unit that is pre-assembled onto the garage door shaft. The power unit is non-handed so as to permit installation at either or both ends of the shaft, as well as in a paired side-by-side relationship along one end.

### CROSS REFERENCE TO RELATED APPLICATION

This U.S. Utility Patent Application claims the benefit of and priority to U.S. Provisional Patent Application Ser. No. 62/489,685 filed Apr. 25, 2017, the disclosure of which is incorporated herein by reference in its entirety.

### FIELD

The present disclosure relates generally to a powered garage door opener for powering a garage door between an open and closed position. More particularly, the powered garage door opener of the present disclosure is a shaft-mounted assembly providing reduced packaging and noise while improving ease of assembly.

### BACKGROUND

This section of the disclosure provides background information which is not necessarily prior art.

A typical garage door assembly has a guide track system supporting a garage door for movement between open and closed positions, a pulley and cable system connecting the garage door to a wall-mounted shaft, and a torsion spring connected to the shaft to assist in lifting the garage door. In addition, many garage door assemblies also include an electrically-powered garage door opener. Garage door openers are typically mounted along the ceiling of a garage. These “overhead” garage door openers typically include an electric motor and a drive system (i.e. screw, belt or chain) driven by the electric motor and which is attached directly to the top garage door panel for driving the garage door between its open and closed positions. However, overhead garage door openers are often relatively large in size, consume a significant amount of ceiling space within the garage, and are difficult to install.

More recently, side-mounted garage door openers have been developed for mounting to the garage wall adjacent the garage door and which are configured to rotatably drive the shaft supporting the garage door. More specifically, these side-mounted garage door openers include an electric motor/geartrain assembly having an output coupled to the shaft operable to rotate the shaft in opposing directions to drive the garage door between its open and closed positions. However, current side-mounted garage door openers include complex geartrains driven by large electric motors to generate sufficient torque to rotate the shaft and operate the garage door between the open and closed positions. In addition, current side-mounted garage door openers are known to generate objectionable noise levels during operation, are extremely difficult to install—particularly in low vertical height garages, and susceptible to de-spooling of the door cables due to fast garage door movement. Thus, a recognized need exists to develop advanced side-mounted garage door openers which overcome these and other shortcomings and provide an improvement in the art of powered garage door systems.

### SUMMARY OF THE INVENTION

This section provides a general summary of various features, aspects and advantages associated with the inventive concepts embodied in the present disclosure and is not intended to be considered as a complete and comprehensive listing of its full scope of protected subj ect matter.

According to one aspect of the disclosure, a powered garage door opener is provided for operating a garage door between an open and closed position. The powered garage door opener includes an electric motor and geartrain assembly operatively coupled to the garage door to drive the garage door between open and closed positions. A power supply is electrically coupled to the electric motor and geartrain assembly. A control module is electrically coupled to the power supply and the electric motor and geartrain assembly for controlling selective actuation of the electric motor and geartrain assembly. The electric motor and geartrain assembly includes an electric motor which drives a gear reduction unit for driving a driven output shaft that is coupled to a shaft associated with the garage door assembly. The electric motor provides electrical power to drive the gear reduction unit for rotating the driven output shaft to provide power actuation of the garage door and wherein the gear relationship between the gears of the gear reduction unit allows the motor to be back-driven and provides manual actuation of the garage door assembly.

According to another aspect of the invention, a side-mounted powered garage door opener is provided for operating a garage door between an open and closed position. The side-mounted powered garage door opener includes a main housing adapted to be mounted to a garage wall adjacent the garage door, and an electric motor and geartrain assembly mounted within the main housing and operatively coupled to the garage door assembly to drive the garage door between open and closed positions. A power supply is mounted within the main housing and is electrically coupled to the electric motor and geartrain assembly. A control module is mounted within the main housing and is electrically coupled to the power supply and the electric motor and geartrain assembly for controlling selective actuation of the electric motor and geartrain assembly. The electric motor and geartrain assembly includes a secondary housing, an electric motor housed within the secondary housing, a worm gear coupled to and driven by the electric motor, a spur gear in meshed engagement with the worm gear, and a driven output shaft mounted to the spur gear and adapted to be coupled to a shaft associated with the garage door. The electric motor provides electrical power to drive the worm and spur gears rotating the driven shaft to provide power actuation of the garage door and wherein the secondary housing isolates and seals the electric motor within the main housing.

In accordance with these and other aspects, the side-mounted powered garage door opener of the present disclosure is non-handed such that a commonly configured power unit can be installed to either end of a shaft associated with the garage door assembly. Pulley and cable assemblies operatively couple the garage door to the shaft such that rotation of the shaft via operation of the powered garage door opener results in movement of the garage door between its open and closed positions. A pulley guard assembly is installed on each of the pulleys to inhibit de-spooling of the cable wound thereon.

The non-handed version of the powered garage door opener of the present disclosure is configured to permit a pair of such powered garage door openers to be installed in a side-by-side orientation along one end segment of the shaft or installed at opposite end segments of the shaft.

The non-handed version of the powered garage door opener of the present disclosure is configured to utilize a two-piece split coupler ring unit mounted to the shaft and the power unit is configured to include a pass-thru driven shaft adapted to be installed over the end of the shaft and slid inwardly until the coupler ring unit is drivingly installed in the pass-thru driven shaft. This “pass-thru” drive output of the power unit facilitates the side-by-side installation of a pair of powered garage door openers if desired.

The non-handed version of the powered garage door opener of the present disclosure has a reduced width dimension in proximity to the pass-thru driven shaft to provide improved installation packaging.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Advantages of the present disclosure will be readily appreciated as the same becomes better understood by reference to the following detailed description when considered in connection with the accompanying drawings wherein:

FIG. 1 is an isometric view of a powered garage door opener operatively coupled to a shaft of a garage door assembly and a lock assembly operatively coupled to a garage door guide track;

FIG. 2 is an inside isometric view of the powered garage door opener shown in FIG. 1;

FIG. 3 is an outside isometric view of the powered garage door opener operatively coupled to the shaft of the garage door assembly and with a housing cover removed;

FIG. 4 is a partially exploded isometric view of an electric motor and geartrain assembly associated with the powered garage door opener with a motor housing cover removed;

FIG. 5A is an isometric view of the lock assembly operatively coupled to the guide track and operating in a locked condition;

FIG. 5B is a side view of the lock assembly shown in FIG. 5A operating in the locked condition;

FIG. 6A is an isometric view of the lock assembly operating in an unlocked condition;

FIG. 6B is a side view of the lock assembly shown in FIG. 6A operating in the unlocked condition;

FIG. 7A is an isometric view an alternative embodiment of the lock assembly operating in a locked condition;

FIG. 7B is a isometric view of the alternative lock assembly shown in FIG. 7A attached to a garage door track;

FIG. 8A is an isometric view the alternative lock assembly operating in an unlocked condition;

FIG. 8B is a isometric view of the alternative lock assembly shown in FIG. 8A attached to a garage door track;

FIG. 9 is an isometric view of an alternative embodiment of the electric motor and geartrain assembly;

FIG. 10 is another isometric view of the alternative electric motor and geartrain assembly shown in FIG. 9 with a top gear support plate removed;

FIG. 11 is an isometric view of a powered side-mounted garage door opener operatively coupled to a first end of the shaft of the garage door assembly and which is constructed in accordance with the teachings of the present disclosure;

FIG. 12 is an isometric view of the powered side-mounted garage door opener operatively coupled to a second end of the shaft of the garage door assembly and which is operable alone or in combination with the arrangement shown in FIG. 11;

FIG. 13A is a partially exploded isometric view of the powered side-mounted garage door opener coupled to the second end of the shaft and FIG. 13B is a partially exploded isometric view of the powered side-mounted garage door opener operatively coupled to the first end of the shaft, as shown in FIG. 12;

FIG. 14 is a side isometric view of the side-mounted garage door opener of the present disclosure;

FIG. 15 is a side elevational view of the side-mounted garage door opener;

FIG. 16 is a front elevational view and FIG. 17 is a bottom elevational view of the side-mounted garage door opener;

FIG. 18 illustrates an assembled isometric view of a pulley guard assembly configured for inhibiting de-spooling of the cable from a shaft-mounted cable pulley;

FIG. 19 is an exploded isometric view of the pre-assembled pulley guard assembly shown in FIG. 18;

FIG. 20 illustrates an isometric view of the assembled pulley guard assembly with the shaft and pulley removed for additional clarity;

FIG. 21 is another exploded pre-assembled isometric view of the pulley guard assembly;

FIGS. 22A and 22B respectively illustrate a comparison of a first version of a powered garage door opener (GDO-V1) with respect to the powered garage door opener (GDO-V2) of the present disclosure; and

FIGS. 23A and 23B also illustrate a visual comparison of GDO-V1 versus GDO-V2 to better distinguish the packaging improvement provided by the present disclosure.

### DETAILED DESCRIPTION OF THE EMBODIMENTS

Example embodiments of a powered, side-mounted garage door opener are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

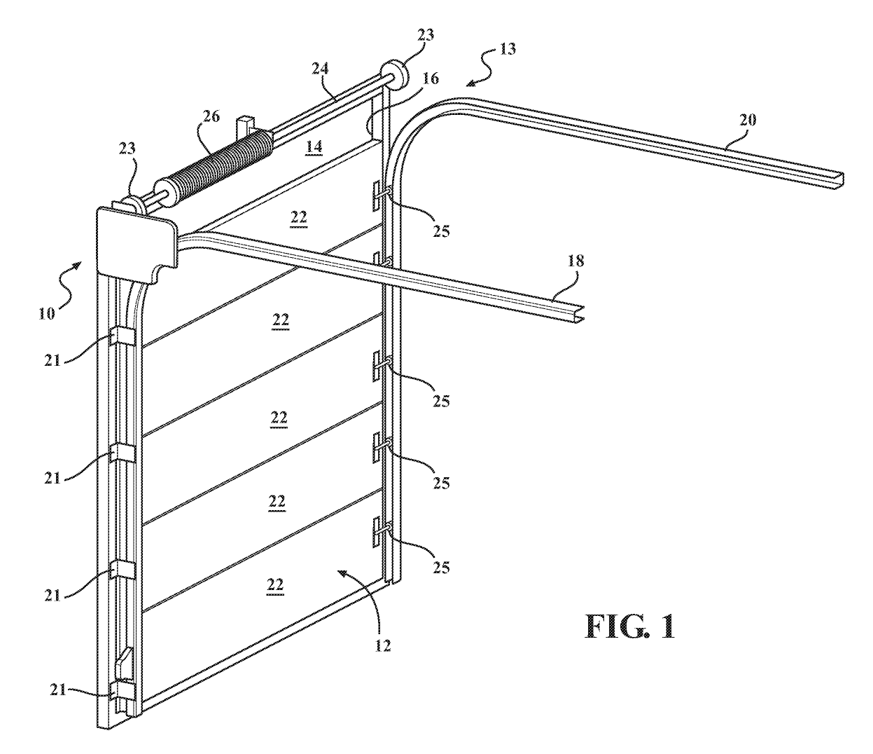

Referring initially to FIGS. 1-10, wherein like numerals indicate like or corresponding parts throughout the several views, a powered garage door opener according to a first embodiment is generally shown at 10 and which is operable for opening and closing a garage door generally shown at 12. An upright planar garage wall 14 defines a garage door opening 16 which is opened and closed by garage door 12.

Referring to FIG. 1, garage door 12 is part of a garage door assembly 13 which also includes a pair of parallel and spaced apart guide tracks 18, 20 fixedly secured by brackets 21 to garage wall 14 along opposing sides of opening 16. Garage door 12 includes a plurality of garage door panels 22 that are pivotally interconnected along their longitudinal sides by a plurality of pivot brackets and are retained within guide tracks 18, 20 along their lateral sides by a plurality of roller wheels 25. Garage door assembly 13 also includes an elongated shaft 24 that is rotatably coupled to garage wall 14 above opening 16, with each distal end supporting a pulley 23. A cable is wound around each pulley 23 and includes a first end fixed to pulley 23 and a second end fixed to the bottom door panel 22 for guiding the interconnected door panels 22 along guide tracks 18, 20 upon rotation of shaft 24 for moving garage door 12 between a closed position covering opening 16 and an open position spaced above opening 16. A torsion spring 26 is wound about shaft 24 for assisting rotation of shaft 24 and raising garage door 12 to the open position. The pre-loaded torque on torsion spring 26 may be adjusted at the time of installation to adjust the assist level in raising garage door 12 or stopping door movement at all positions between the open and closed positions as desired.

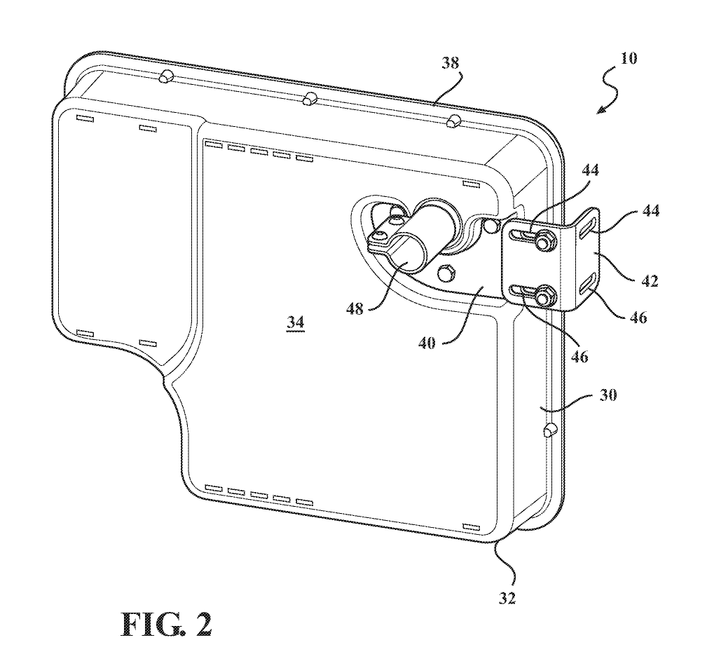

Powered garage door opener 10 is fixedly mounted to garage wall 14 adjacent one side portion of opening 16 and is operatively coupled to one end of shaft 24 for rotating shaft 24 and facilitating actuation of garage door 12 between the open and closed positions. Thus, powered garage door opener 10 can also be referred to as a “side-mounted” or “shaft-mounted” garage door opener. Referring to FIGS. 2-4, powered garage door opener 10 includes an outer housing 30 made of plastic or metal. Outer housing 30 includes a bin 32 forming a cavity extending from a back plate 34 and a peripheral flange 35 to define a front opening 36, and a cover 38 for covering the front opening 36 of bin 32. A metal or plastic housing attachment bracket 40 is fixedly attached to back plate 34 of bin 32 by bolts or the like. A metal or plastic adjustable L-shaped bracket 42 is mounted to attachment bracket 40 for mounting garage door opener 10 to garage wall 14 adjacent garage door assembly 13, as shown in FIG. 1. Each leg of L-shaped bracket 42 includes a pair of elongated slots 44, 46 for receiving mounting bolts therethrough and provides alignment adjustment for mounting of garage door opener 10 to garage wall 14. Additionally, a shaft coupling 48 projects outwardly from back plate 34 of bin 32 for coupling a driven shaft 84 of garage door opener 10 to one of the distal ends of garage door shaft 24, as will be described in further detail below.

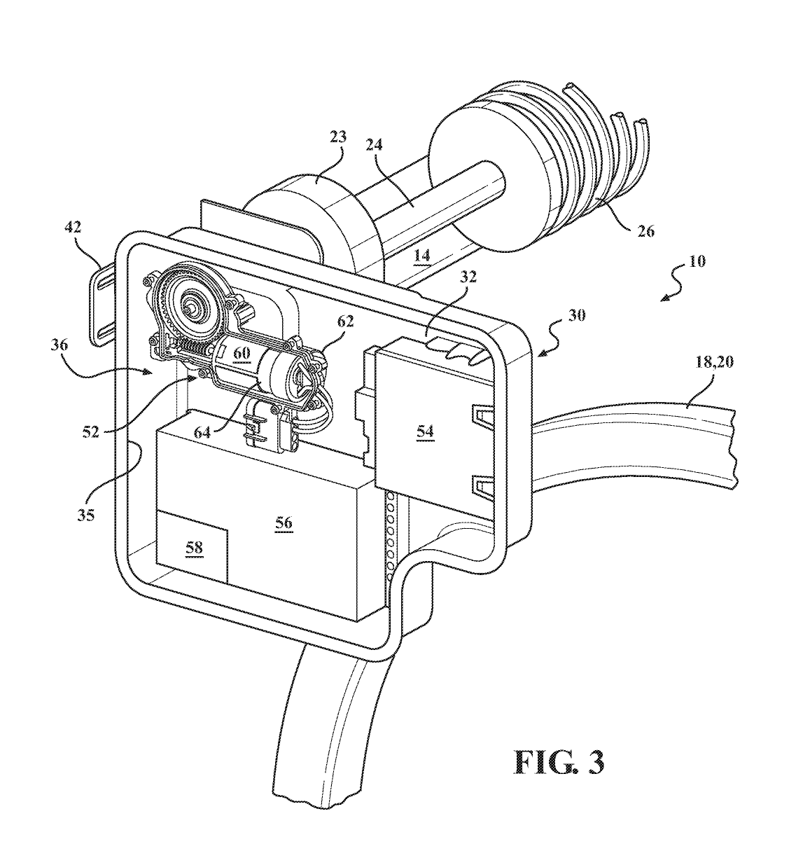

Referring to FIG. 3, garage door opener 10 is shown mounted to garage wall 14 adjacent garage door assembly 13 and operatively coupled to shaft 24. Cover 38 of outer housing 30 has been removed to disclose the cavity within bin 32. Bin 32 houses an electric motor and geartrain assembly 52 having driven shaft 84 operatively coupled via shaft coupling 48 to shaft 24, an electronic control module 54 electrically connected to electric motor and geartrain assembly 52, and a power supply 56 electrically connected to electronic control module 54 and electric motor and geartrain assembly 52 for providing power thereto. More specifically, power supply 56 is a 12V DC output power supply which may be powered by a standard household AC outlet on garage wall 14. Power supply 56 may also include a 12V DC 12 amp battery or other energy storage device 58, such as capacitors, or supercapacitors, to provide power to electric motor and geartrain assembly 52, and also the lock assemblies 90, 90′ described hereinbelow, in the event of an electrical power failure. The battery or energy storage device 58 may be plugged into the AC outlet with a trickle charger to maintain the battery charge or connected to a solar power system as are commonly known and readily available.

Electronic control module 54 may be software controlled to actuate electric motor and geartrain assembly 52 and rotate driven shaft 84 for concurrently driving shaft 24 to drive the interconnected garage door panels 22 between the open and closed positions. Electronic control module 54 may be controlled remotely by a wireless vehicle controller, a wired or wireless controller mounted to garage wall 14, a wireless key fob-type controller, a mobile phone/smart phone application, or any other type of transmitter for providing a control signal to module 54. When more than one powered garage door opener 10 is installed on the same garage door shaft 24, the respective electronic control modules 54 may be encoded to simultaneously respond to the same control signal.

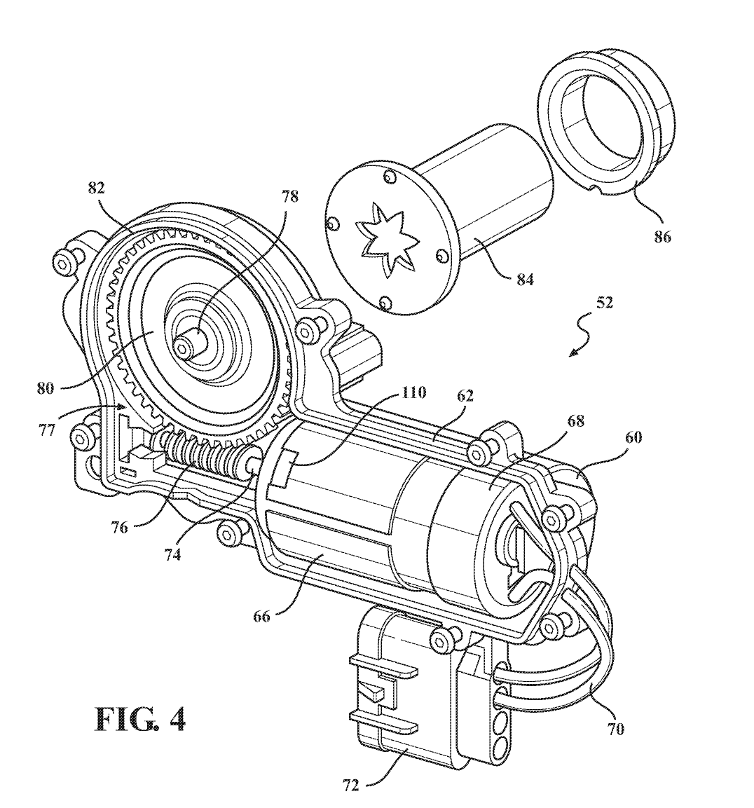

Referring to FIGS. 3 and 4, electric motor and geartrain assembly 52 comprises a sealed motor-geartrain housing 60 which is fixedly mounted within the cavity of bin 32 of outer housing 30. In this manner, electric motor and geartrain assembly 52 is separately isolated and sealed within its housing 60 and within outer housing 30. Sealed housing 60 provides a completely greased, sealed, and maintenance free assembly of motor and geartrain assembly 52 isolated and secured within outer housing 30. Further, isolating and sealing motor and geartrain assembly 52 within housing 60 from outer housing 30 allows for air flow within outer housing 30 to cool electric control module 54 and power supply 56. Motor-geartrain housing 60 includes a body 62 defining a cavity and a cover 64 for covering the body 62 and closing the cavity. FIG. 4 shows motor and geartrain assembly 52 with cover 64 removed. A 12V DC motor 66 is secured in a cylindrical portion of body 62 by a rubber vibration damper strap or sleeve 68 to isolate noise and vibration from motor 66 within housing 60. An electrical wiring harness 70 and a coupling 72 extend from one end of electric motor 66 and through housing 60 for electrical connection to electronic control module 54 and power supply 56.

A motor shaft 74 extends from the opposite end of motor 66 and supports a single stage worm gear 76 of a gear reduction unit 77 (“reduction gearset”), which is preferably made of bronze. The gear reduction unit 77 further includes a gear shaft 78 extends through the bottom of body 62 and rotatably supports a spur or wheel gear 80, which is preferable made of plastic. Brass worm gear 76 and plastic wheel gear 80 achieve a low coefficient of friction for back driving while meeting strength requirements for durability. Spur gear 80 includes outer peripheral teeth 82 in meshed engagement with threads on worm gear 76, whereby rotation of worm gear 76 by motor 66 causes rotation of spur gear 80 and gear shaft 78. The gear ratio between worm gear 76 and spur gear 80 is preferably in the range of about 57:1 to allow worm gear 76 to be manually back driven by spur gear 80 during manual operation of garage door assembly 12. The worm gear lead angle also allows worm gear 76 to be manually back driven by spur gear 80. It should be appreciated that other gear ratios may be selected which will also allow worm gear 76 to be back driven by spur gear 80. Additionally, the use of a bronze worm gear 76 and a plastic spur gear 80 provides for low sound output during operation of motor 66 and driving of gears 76, 80. Driven shaft 84 and plastic or bronze bushing 86 are secured to gear shaft 78 for rotation therewith. Finally, shaft coupling 48 interconnects driven shaft 84 and garage door shaft 24 such that actuation of motor 66 facilitates rotation of garage door shaft 24 and movement of door panels 22 between the open and closed positions.

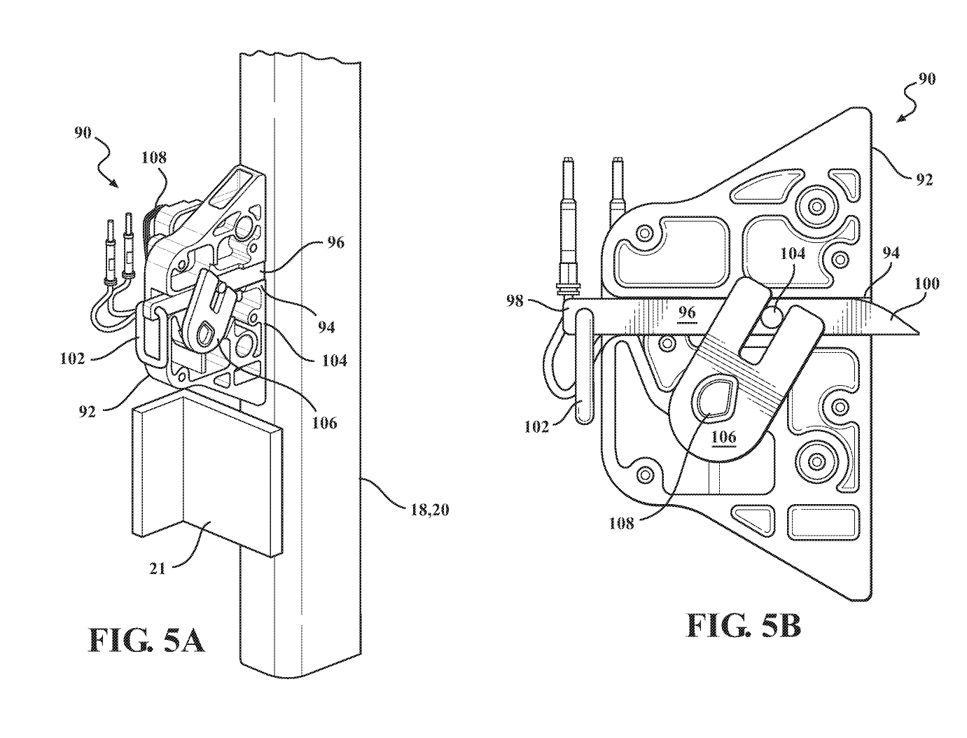

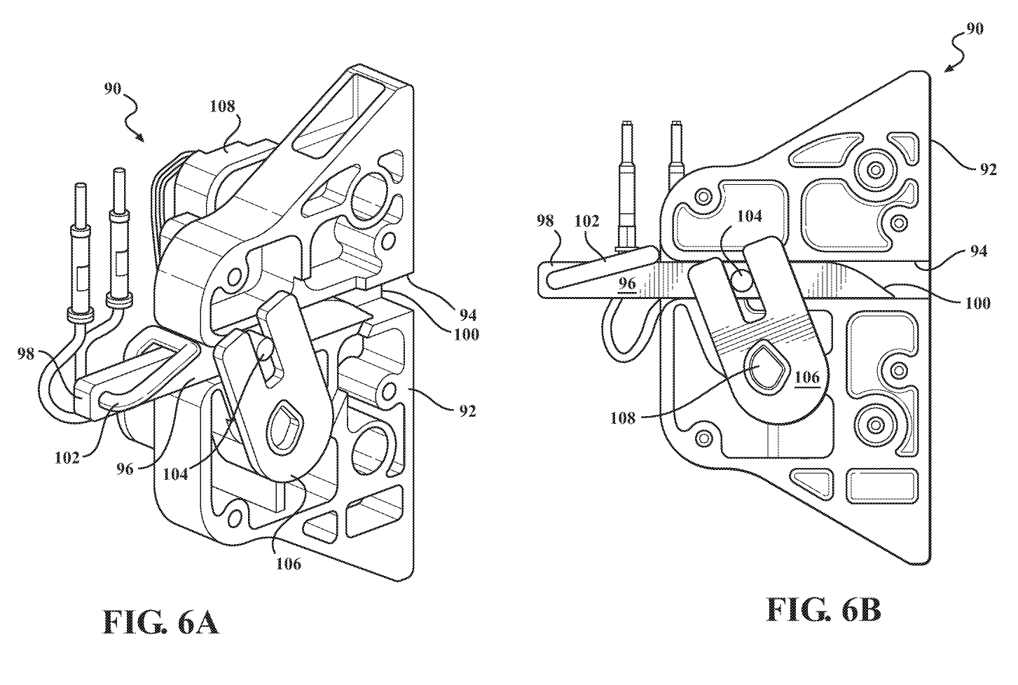

Referring now to FIGS. 5A-6B, powered garage door opener 10 is further shown to include a lock assembly 90 to enable locking and unlocking of garage door 12 in the closed position. Lock assembly 90 includes a carriage 92 for mounting lock assembly 90 to one of tracks 18, 20 adjacent the bottom door panel 22. Carriage 92 includes a lateral through-bore 94 for slidably receiving and guiding an elongated sliding bar 96 therein. Sliding bar 96 extends longitudinally between a first end 98 and an opposite second tapered or ramped second end 100. A release ring 102 is coupled to first end 98 for manually sliding slide bar 96 through bore 94. A guide pin 104 projects laterally from sliding bar 96. A fork arm 106 extends between a first end pivotally coupled to carriage 92 and an opposite U-shaped second end slidably coupled to guide pin 104. An electric, spring-loaded solenoid actuator 108 is operatively coupled to fork arm 106 and electrically connected to electronic control module 54 and power supply 56 for actuating lock assembly 90 between a locked condition, as shown in FIGS. 5A and 5B, wherein sliding bar 96 engages one of the wheels on garage door panels 22 to lock door panels 22 in the closed position, and an unlocked condition, as shown in FIGS. 6A and 6B, wherein sliding bar 96 is retracted and disengaged from the wheel to unlock door panels 22 and allow movement to the open position.

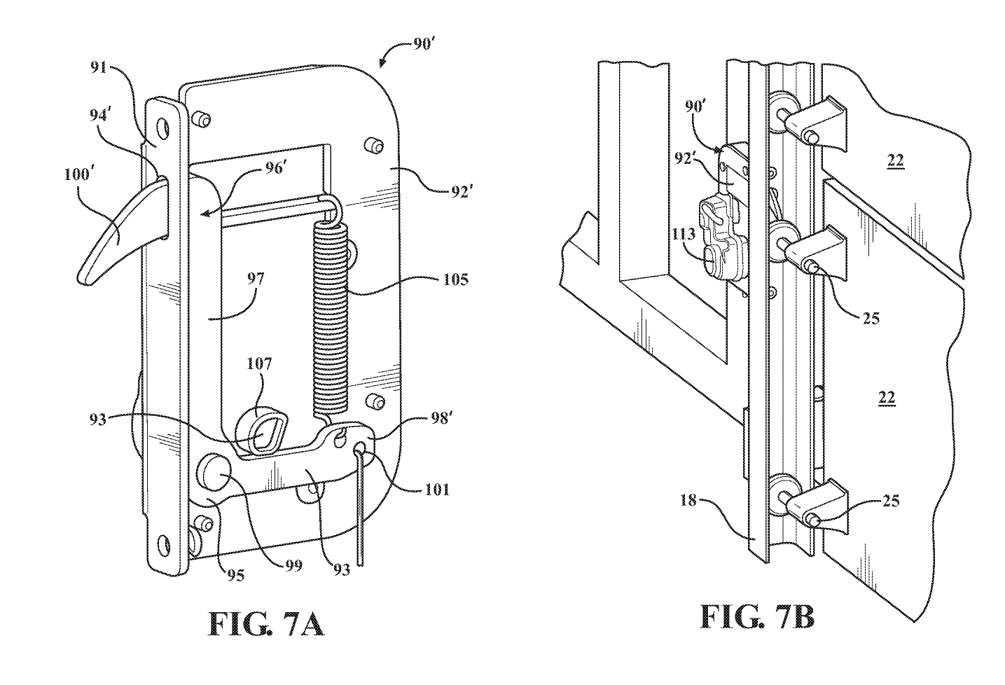

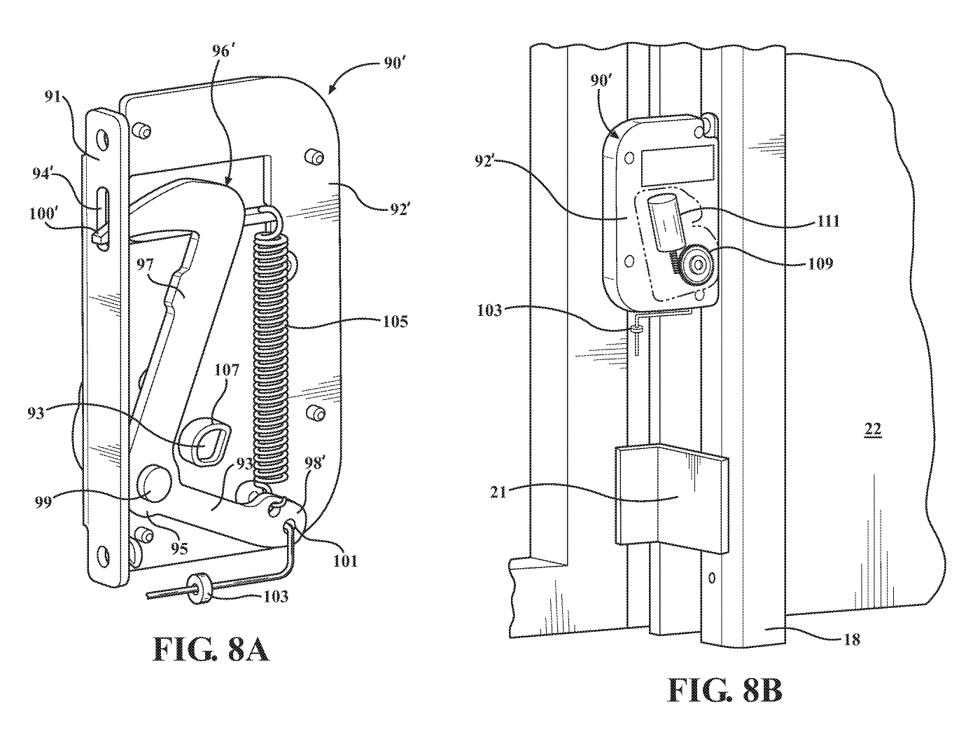

Referring now to FIGS. 7A-8B, an alternative embodiment of a lock assembly 90′ is shown. The alternative version of the lock assembly 90′ also enables locking and unlocking of garage door 12 in the closed position. Lock assembly 90′ includes a carriage 92′ for mounting lock assembly 90′ to one of tracks 18, 20 adjacent the bottom door panel 22. Carriage 92′ includes a front surface 91 defining a through-bore 94′ for slidably receiving and guiding a hook 96′ therein. The hook 96′ extends from a first end 98′ along a first section 93 to a bend 95 and from the bend 95 along a second section 97 to an opposite tapered or ramped second end 100′ that extends at a transverse angle from the second section 97. A post 99 extends through the bend 95 and forms a pivot axis of the hook 96′, wherein pivoting of the hook 96′ with respect to the pivot axis moves the second tapered section 100′ in the through-bore 94′ in a locked condition and out of the through-bore 94′ in an unlocked condition. The first end 98′ includes a pull chord aperture 101 for attachment to a pull chord 103 so that manual downward pulling of a pull chord 103 pivots the hook 96′ between conditions. A spring 105 extends between the first end 98′ and the carriage 92′ biasing the hook 96′ toward the closed condition. An actuator 108′ having a cam surface 107 is electrically connected to and rotated by a gear wheel 109 that is mechanically driven by a lock assembly motor 111. The cam surface 107 is ramped and disposed adjacent to the first section 93 of the hook 96′ and rotation of the cam surface 107 guides the first section 93 downward or upward between conditions, pivoting the hook 96′. The gear wheel 109 and lock assembly motor 111 are contained within a lock assembly housing 113 attached to the carriage 92′. The lock assembly motor 111 is electronically connected to electronic control module 54 and power supply 56 for actuating lock assembly 90′ between the locked condition, as shown in FIGS. 7A and 7B, wherein hook 96′ engages one of the wheels on garage door panels 22 to lock door panels 22 in the closed position, and the unlocked condition, as shown in FIGS. 8A and 8B, wherein hook 96′ is retracted and disengaged from the wheel to unlock door panels 22 and allow movement to the open position.

In operation, with garage door 12 in the closed position and lock assembly 90, 90′ in the locked condition, a mobile phone or other wired or wireless transmitter may be pressed to actuate powered garage door opener 10. The transmitter sends a signal to electronic control module 54 to open garage door 12. For example, during operation of the first embodiment lock assembly 90, the module 54 powers and activates solenoid actuator 108 to pivot the fork arm 106 counterclockwise, as shown in the Figures, retracting and disengaging sliding bar 96 from one of the wheels 25 and maintaining lock assembly 90 in the unlocked condition. Module 54 and power supply 56 further then power motor 66 to rotate worm gear 76 and spur gear 80. Driven shaft 84 extending from spur gear 80 is coupled to garage door shaft 24 via shaft coupling 48 to transfer torque from the driven shaft 84 to shaft 24. Torsion spring 26 assists in the rotation of shaft 24 and pulleys 23 wind the cables to slide the interconnected garage door panels 22 along tracks 18, 20 from the closed position to the open position.

Motor 66 may also include a sensor or encoder 110 to monitor and determine the position and speed of the garage door 12 and define the open and closed positions. The sensor or encoder 110, along with software within control module 54, allows for adjustment and control of the speed and position of door panels 22 as well as the ability to determine if an obstacle presence is within opening 16 or blocking the path of door panels 22 during operation of the door. Sensor or encoder 110, along with the software within control module 54, may also vary the speed of the motor 66 to slowly accelerate and/or decelerate the door panels 22 and vary the travel of door panels 22 for different sized garage door openings. Garage door assembly 13 may alternatively include an infrared sensor system attached to garage door tracks 18, 20 to detect the presents of an obstacle or an ultrasonic sensor or pinch strip mounted to bottom panel 22 of garage door 12. An obstacle can be detected by the sensor detecting no movement of garage door 12 when garage door opener 10 is being driven. Other obstacle detection techniques such as sensing motor current, or optical, ultrasound, or capacitive sensing in the plane of the door can be used. Additionally, in the event of an electrical power failure, motor 66 may be powered and driven by backup battery power supply 58.

Garage door 12 may also be moved manually between the open and closed positions without decoupling or damaging powered garage door opener 10. In manual operation, release ring 102 is pulled to retract and disengage sliding bar 96 from one of wheels 25 and then rotated upwardly and wedged against carriage 92 to shift lock assembly 90 in the unlocked condition, as shown in FIGS. 7 and 8. Manually lifting of door panels 22 rotates main shaft 24, with assistance by torsion spring 26. The lead angle of worm gear 76 and/or the gear ratio between worm gear 76 and spur gear 80 allows the rotation of main shaft 24 to be transferred to driven shaft 84 to safely back drive worm gear 76 without damaging gears 76, 80 or motor 66. Alternatively, control module 54 may be programmed to operate in a hybrid power lift assist mode wherein the user manually operates the door between the open and closed positions and powered garage door opener 10 actuates motor 66 to provide additional lift assistance to door panels 22 thereby reducing the effort required to operate garage door 12 between the open and closed positions. Because garage door opener 10 is back drivable, opener 10 is more mechanically efficient and consumes less power to raise and lower garage door 12. The greater efficiency also reduces the package size to do the required work. Additionally, providing a back drivable opener 10 alleviates the need for complex mechanisms for decoupling the motor and geartrain assembly in manual operation.

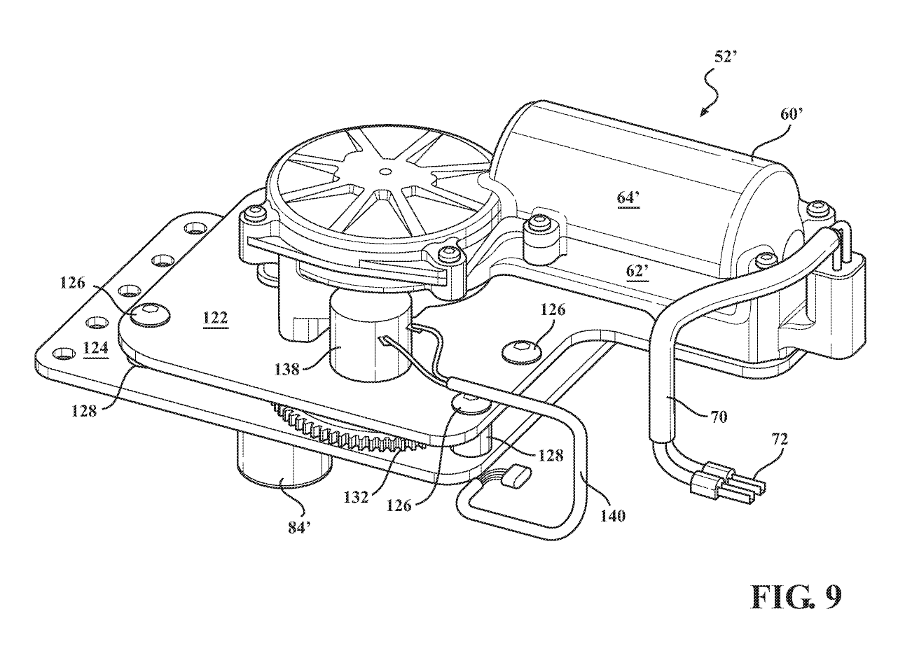

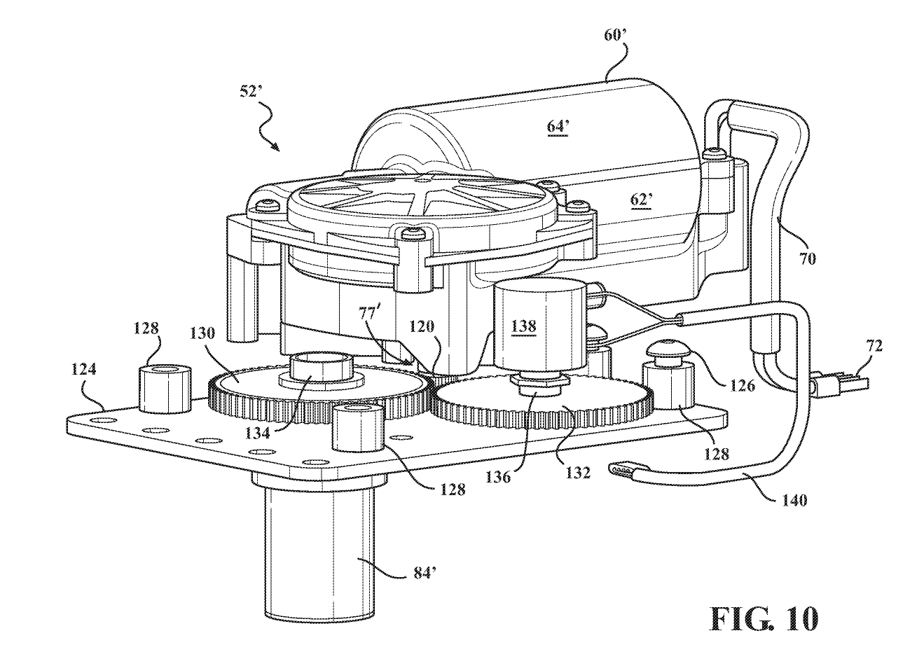

Referring now to FIGS. 9 and 10, an alternative embodiment of an electric motor and geartrain assembly is shown at 52′. The alternative version of electric motor and geartrain assembly 52′ includes a sealed motor-geartrain housing 60′ which is fixedly mounted within the cavity of bin 32 of outer housing 30 as in the first embodiment of FIG. 3. Housing 60′ includes a body 62′ defining a cavity and a cover 64′ for covering body 62′ and closing the cavity. As in the first embodiment, motor 66 is secured in body 62′ and the electrical wiring harness 70 and coupling 72 extend from motor 66 and through housing 60′ for electrical connection to electronic control module 54 and power supply 56. Motor shaft 74 extending from motor 66 supports worm gear 76 which is in meshed engagement with teeth 82 of spur gear 80. Spur gear 80 is fixedly supported on gear shaft 78 as previously discussed and shown in FIG. 4.

In the alternative embodiment, a driven gear 120 is fixedly secured to the opposite distal end of driven gear shaft 78 on the outside of housing 60′. The alternative electric motor and geartrain assembly 52′ includes a pair of spaced apart and parallel first and second gear support plates 122, 124. First gear support plate 122 (top) is fixedly secured to housing 60′ and second gear support plate 124 (bottom) is fixedly secured to first gear support plate 122 by fasteners 126 with spacers 128 supported therebetween to maintain a spaced gap between plates 122, 124. First and second gear support plates 122, 124 rotatably support second and third driven spur gears 130, 132 therebetween. Driven gear 120 and second and third spur gears 130, 132 of gear reduction unit 77′ are preferably made of metal to increase the strength and durability of motor and geartrain assembly 52′. Additionally, the ratio between the driven gear 120 and second spur gear 130 is preferably in the range of about 5:1 which allows use of a high speed motor 66 while reducing the stress on plastic worm gear 76 and maintaining the strength and durability of assembly 52′. Second spur gear 130 is rotatably supported on a first end of a shaft 134 extending through second (or bottom) gear support plate 124. A driven shaft 84′ is secured to the opposite second end of shaft 134 for rotation therewith and interconnected to garage door shaft 24 by shaft coupling 48. The teeth of second spur gear 130 are in meshed engagement with the teeth of driven gear 120 and thus driven by motor 66. Third spur gear 132 is rotatably supported on a first end of a shaft 136 extending through first (or top) gear support plate 122. A rotary potentiometer 138 is mounted to the opposite second end of shaft 136 for rotation therewith. The teeth of third spur gear 132 are in meshed engagement with the teeth of the second spur gear 130.

In operation, module 54 and power supply 56 power motor 66 to rotate worm gear 76 and spur gear 80 as discussed previously in the first embodiment. Driven gear shaft 78 extending from spur gear 80 drives driven gear 120. Driven gear 120 then rotatably drives second spur gear 130. Driven shaft 84′ extending from shaft 134 of second spur gear 130 is coupled to garage door shaft 24 via shaft coupling 48 to transfer the torque from motor 66 into rotation of shaft 24, thereby moving garage door 12 between the open and closed position. Additionally, second spur gear 130 simultaneously drives third spur gear 132, and therefore, rotary potentiometer 138. Rotary potentiometer 138 is electrically coupled to control module 54 via electrical connector 140 in order to monitor and maintain the absolute position of garage door 12 between the open and closed position in the event of a power failure.

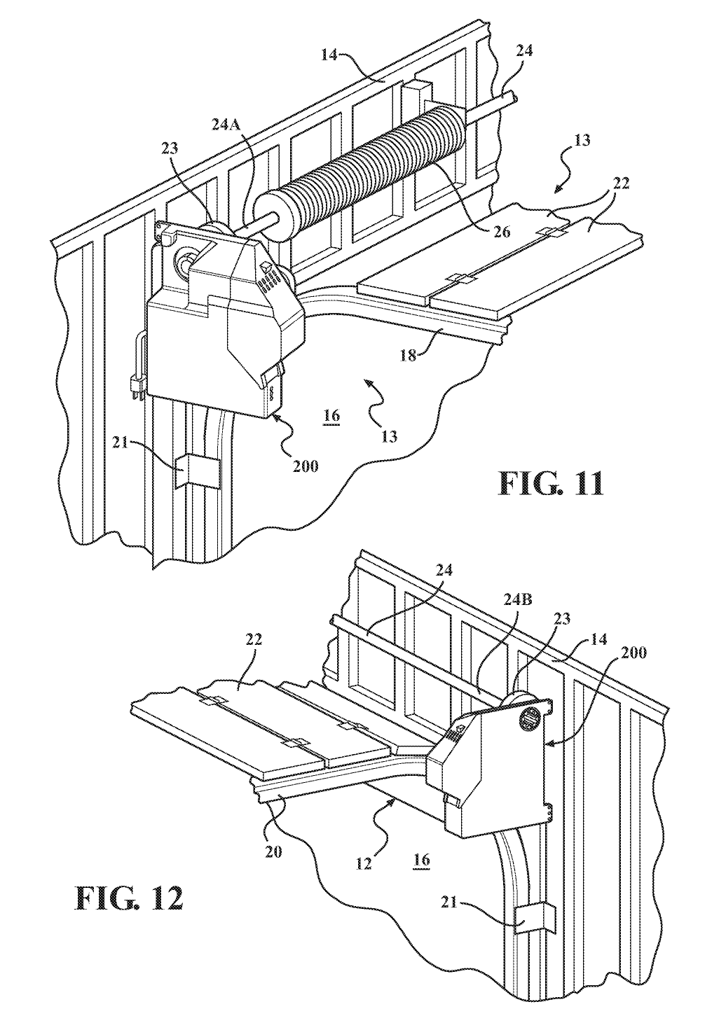

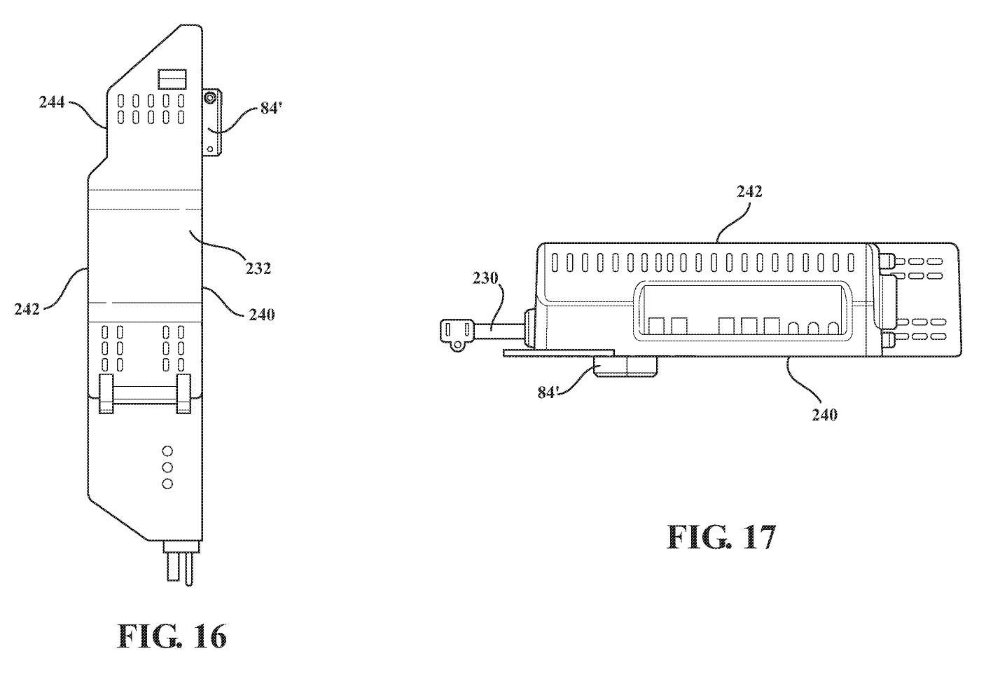

Referring now to FIGS. 11-17, wherein like numerals indicate like or corresponding components throughout the several views, a powered garage door opener 200 according to another embodiment is shown in association with garage door assembly 13 for moving garage door 12 between open and closed positions with respect to opening 16 in garage wall 14. Since many components of garage door assembly 13 were previously disclosed and described in detail, these components are simply identified by the common reference number. FIG. 11 illustrates powered garage door opener 200 operably associated with a first end segment 24A of shaft 24 in proximity to first guide track 18. As an optional installation arrangement, FIG. 12 illustrates powered garage door opener 200 operably associated with a second end segment 24B of shaft 24 in proximity to second guide track 20. It will be understood that a single powered garage door opener 200 can be installed on either side of garage door 12 or, as an alternative, a pair of powered garage door openers 200 can be used on opposite ends of shaft 24. A further alternative option is directed to utilizing a pair of powered garage door openers 200 along only one of shaft end segments 24A or 24B.

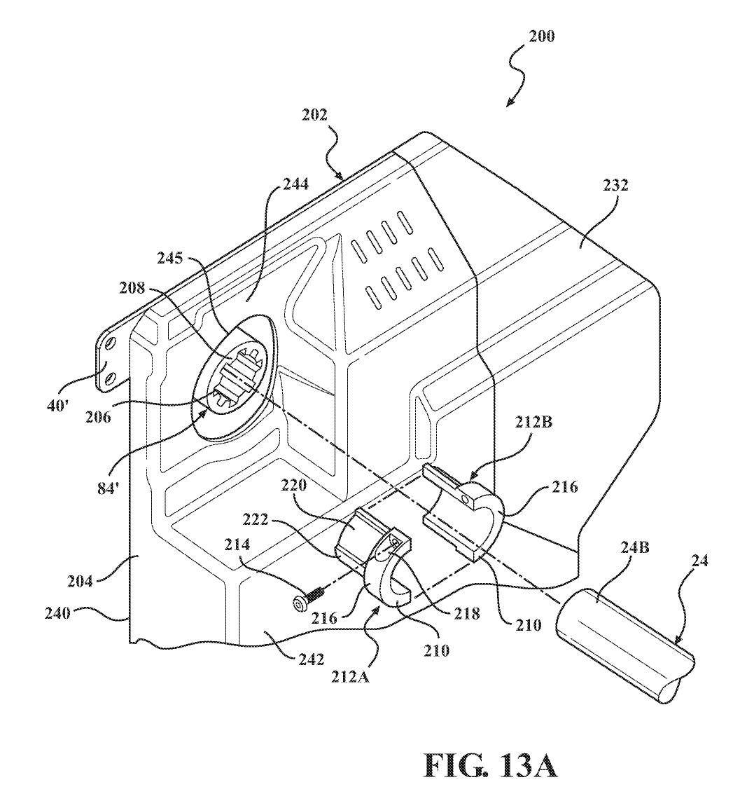

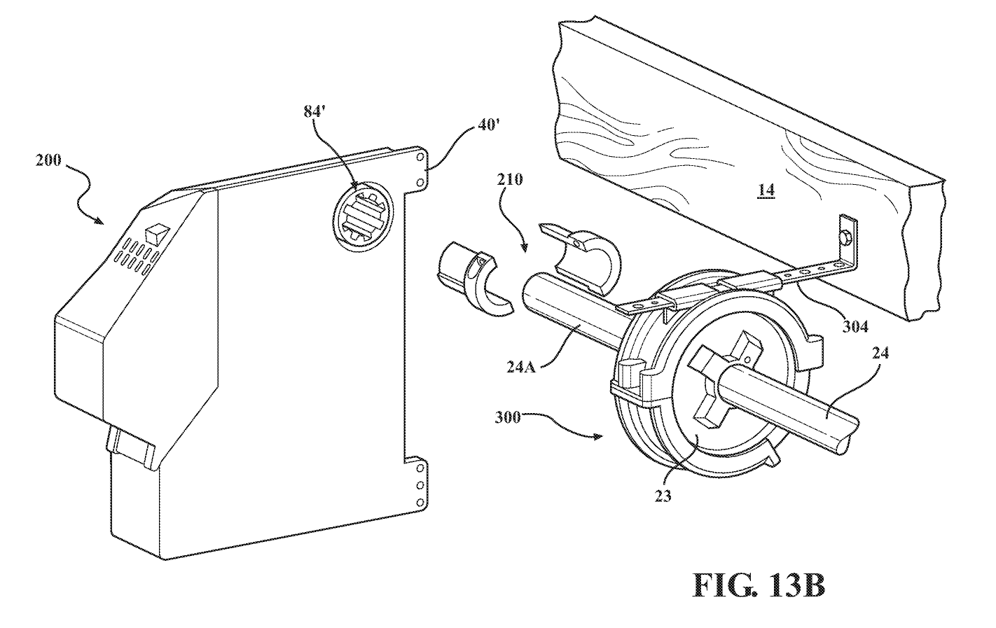

To provide the ability to mount a commonly configured garage door opener 200 along either (or both) ends of shaft 24 or, as a pair mounted along one of guide tracks 18, 20, a modular arrangement is provided having a power unit 202 with a pass-thru driven output shaft 84′ driven by electric motor and geartrain assembly 52, 52′ installed in a power unit housing 204. Pass-thru driven shaft 84′ includes a drive aperture 206 having internal drive projections 208 (i.e. lugs, splines, teeth, etc.) adapted to drivingly engage a coupler unit 210. FIG. 13A illustrates coupler unit 210 as comprising a pair of semi-circular coupler rings 212A, 212B that are interconnected by two or more fasteners 214 to surround and drivingly engage shaft end segment 24B of shaft 24. Coupler unit 210 has a mounting flange segment 216 with mounting bores 218 configured to receive fasteners 214 and a drive stub shaft segment 220 having external drive projections 222 (i.e. lugs, splines, teeth, etc.) configured to matingly engage internal drive projections 208 on driven output shaft 84′. Housing attachment bracket 40 is shown fixedly attached to housing 204 and is configured to receive L-shaped bracket 42 (FIG. 2) for securing the unit to garage wall 14. The two-piece coupler unit 210 is initially clamped onto end segment 24B of shaft 24. Thereafter, power unit 202 is slid over end segment 24B of shaft 24 and onto the assembled coupler unit 210 to positively engage driven shaft 84′ to shaft 24. Finally, opener 200 is fastened to garage wall 14 to prevent axial movement. FIG. 13B is similar to FIG. 13A except that it now illustrates opener 200 mounted via two-piece coupler unit 210 to end segment 24A of shaft.

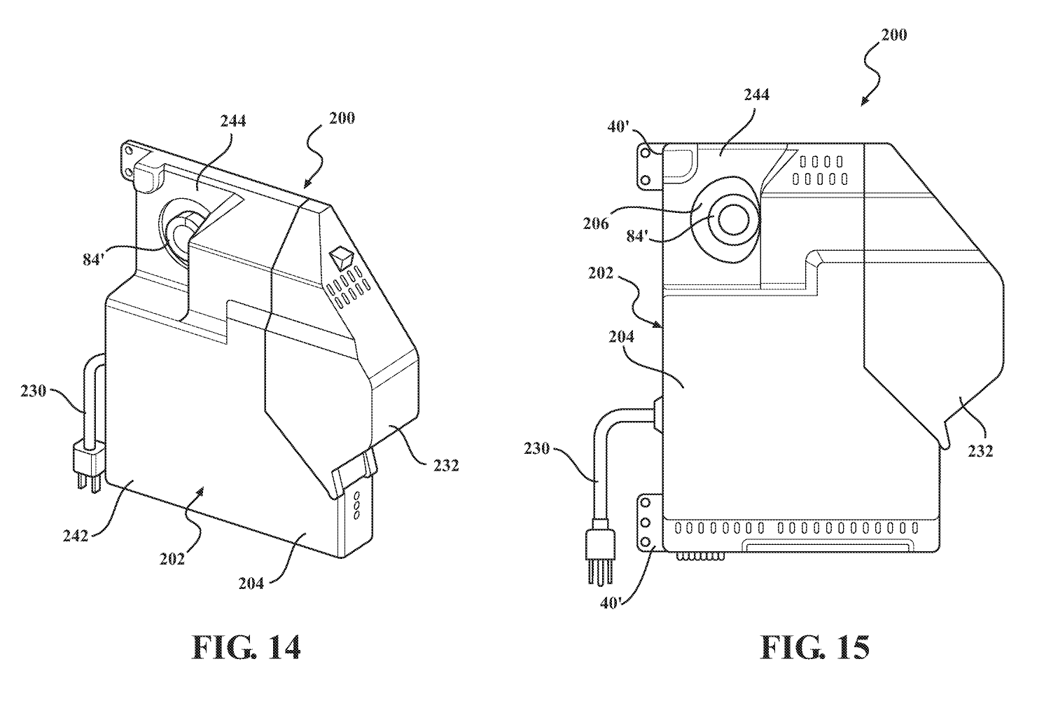

FIGS. 14-17 illustrate powered garage door opener 200 from various different perspectives to clearly identify its slim-line packaging and dual-side (i.e. non-handed) mounting capability. Power unit 202 is a self-contained assembly configured to support and include motor and geartrain assembly 52, electronic control module 54, and power supply 56 similar to that previously disclosed. A power cord 230 permits electrical connection to an electrical outlet. A removable light cover 232 is snap-fit to housing 204 and can be pivoted relative to housing to permit installation of an LED light therein. Power unit 202 defines a planar first surface 240, a planar second surface 242, and a recessed cavity segment 244 formed therebetween and having a first surface corresponding to the planar first surface 240 and a second surface corresponding to a planar second surface 242. The first and second surface of the cavity segment each defining an opening 245 exposing the driven output shaft 84′ extend extending therein.

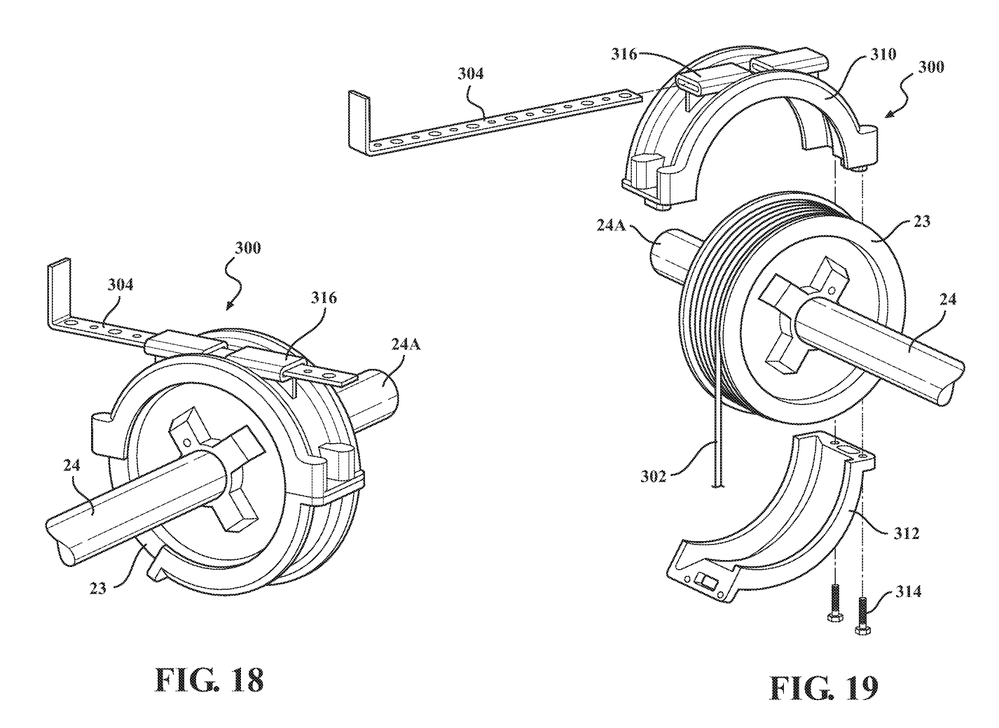

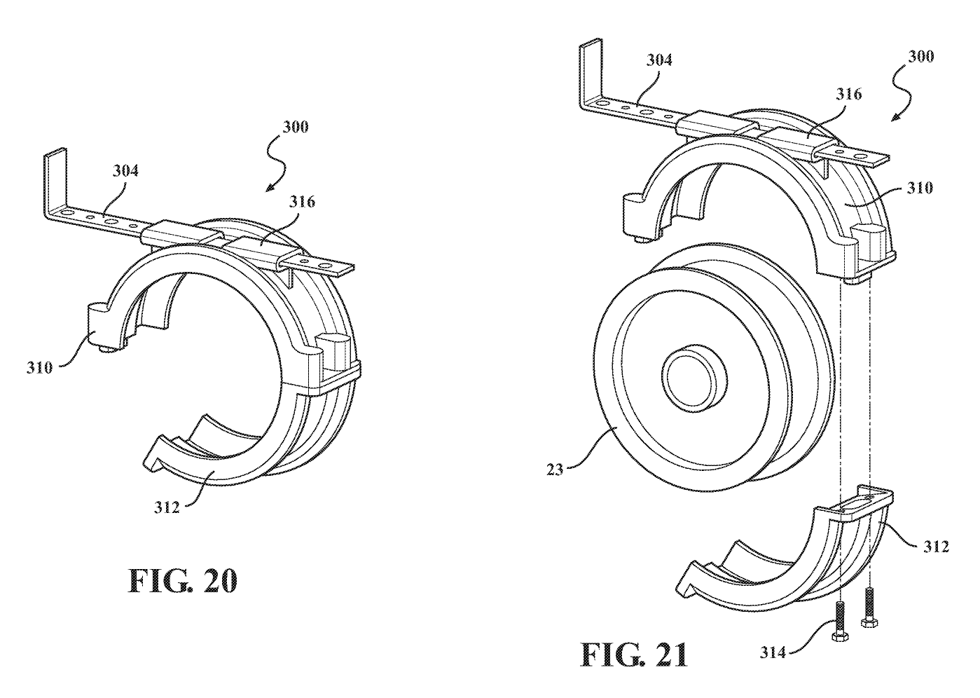

FIGS. 18-21 illustrate a pulley guard assembly 300 configured to surround pulley 23 and prevent de-spooling of a garage door cable 302 from pulley 23. Pulley guard assembly 300 is adapted to be mounted to garage wall 14 via an adjustable mounting bracket 304. Pulley guard assembly 300 includes a first or upper guard segment 310 and a second or lower guard segment 312 configured to be interconnected via a plurality of mounting fasteners 314. Upper guard segment 310 includes a slotted bracket retainer 316 configured to receive an elongated link segment of mounting bracket 304 to provide position adjustment relative to wall 14.

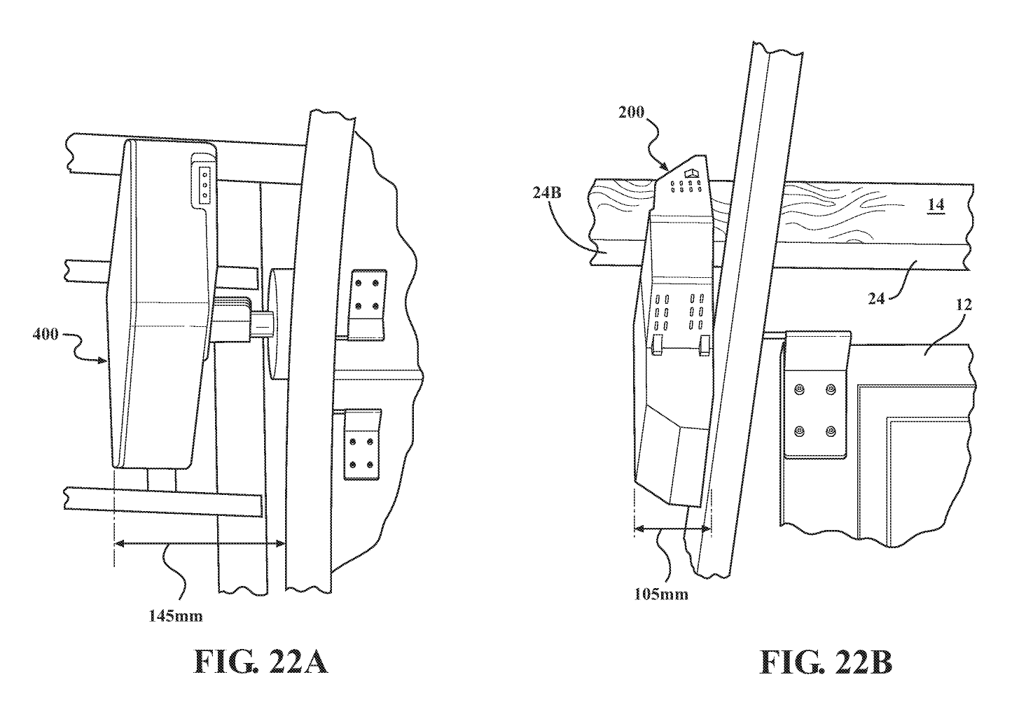

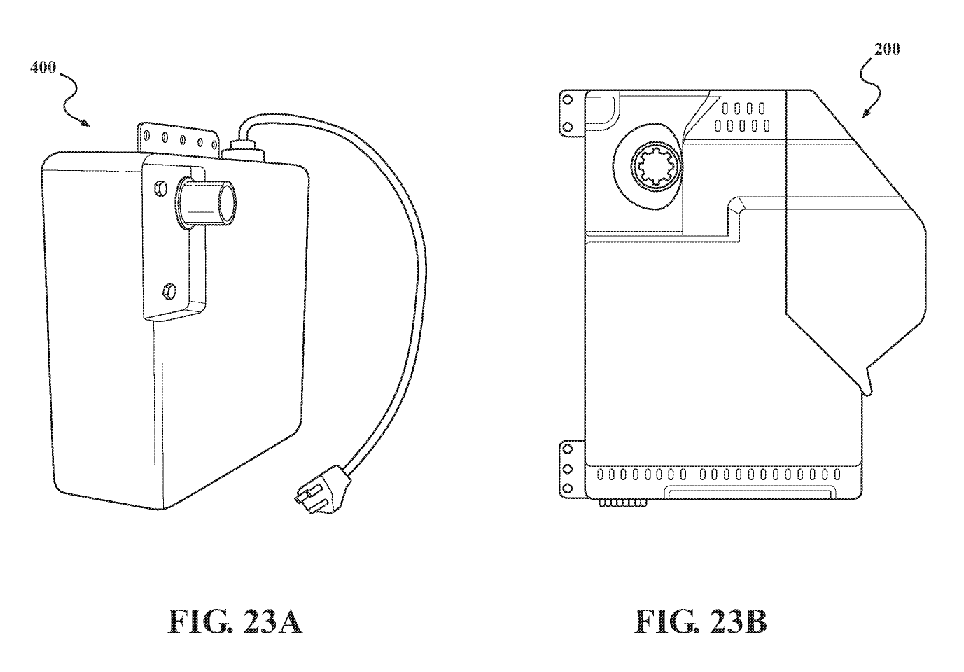

FIGS. 22A and 22B illustrate a side-by-side comparison of a version of a first garage door opener 400 (hereinafter “GDO-V1”) with a second garage door opener 200 (“GDO-V2”). Significant improvements in the critical width dimension is shown with GDO-V1 having a 145 mm width dimension in comparison to GDO-V2 having only a 105 mm width dimension. Further, cavity segment 244 has a maximized/optimized width dimension of only 22 mm. Disadvantages associated with GDO-V1 of FIG. 22A include: A) can only be mounted from one side of garage; B) needs to be mounted to end of shaft 24; and C) two units cannot be mounted side-by-side. In contrast, the advantages associated with GDO-V2 include: A) simplified installation; B) capability to mount to garage wall from either or both sides; and C) two units can be installed in side-by-side manner on one of the ends of shaft 24. Further, GDO-V2 is simpler to install in nonstandard door clearances such that the minimal width (22 mm) at the driven output shaft 84′ was a primary design criteria to overcome prior art deficiencies. Due to the “pass-thru” design of driven output shaft 84′, a coupler unit 210 may be mounted on shaft 24 and then power unit 202 is installed thereon. The flange portion of coupler unit 210 maintains the position of power unit 202 relative to output shaft 84′. As such, multiple openers 200 can be installed in a side-by-side arrangement.

Thus, powered garage door opener 200 provides an improvement of conventional side-mounted powered openers including improved appearance, non-handed feature reduces inventory, improved packaging, improved output torque with no impact on actuation speed, and less speed sensitivity relative to door weight.

Powered garage door opener 200 provides reductions in the cost of the electronic componentry and an optimized output drive ratio (about 12:1) reduces running current and increases available torque at lower current values. Increases in the voltage support the increased operating speeds which, in turn, compensates for the increased ratio. As such, the electric motor operates in a more efficient portion of the power curve and permits the power unit to provide increased lifting forces and speed of door movement. Preferably, garage door opener 200 includes various options including an LED light (instead of light socket), a projector for projecting an image on the garage door floor, a power supply integrated into the printed circuit board (PCB), reduced weight, use of an optical position sensor, and optimized IR sensor configuration.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed:

1. A powered garage door opener for operating a garage door between an open position and a closed position, said powered garage door opener comprising:
an electric motor and geartrain assembly including an electric motor and a reduction gearset driven by said electric motor; and
a control module electrically coupled to said electric motor and geartrain assembly for controlling selective actuation of said electric motor and geartrain assembly, wherein said electric motor and geartrain assembly includes a pass-thru output shaft defining a drive aperture extending therethrough and which is adapted to be coupled to a garage door shaft to drive the garage door between its open and closed positions, wherein said pass-thru output shaft is driven by said reduction gearset for rotating said pass-thru output shaft to provide power actuation of the garage door.

2. The powered garage door opener as set forth in claim 1, further including a coupler unit adapted to be preinstalled on and secured to the garage door shaft and to drivingly engage said pass-thru output shaft.

3. The powered garage door opener as set forth in claim 2, wherein said coupler unit comprises a pair of semi-circular coupler rings for interconnecting around the garage door shaft.

4. The powered garage door opener as set forth in claim 1, wherein said coupler unit includes a mounting flange segment for abutting against said pass-thru output shaft.

5. The powered garage door opener as set forth in claim 2, wherein said pass-thru output shaft includes at least one internal drive projection extending into said drive aperture, and wherein said coupler unit defines at least one external drive projection for drivingly engaging said at least one internal drive projection.

6. The powered garage door opener as set forth in claim 5, wherein said pass-thru output shaft further includes a plurality of peripheral teeth in mating engagement with a worm gear.

7. The powered garage door opener as set forth in claim 1, further including a main housing adapted to be mounted to a garage wall wherein said electric motor and geartrain assembly and said control module are mounted within said main housing.

8. The powered garage door opener as set forth in claim 7, wherein said main housing includes a cavity segment having first surface opposite a second surface, and wherein said first and second surfaces each define an opening exposing said drive aperture of said pass-thru output shaft for accepting the garage door shaft from either of said first and second surfaces.

9. The powered garage door opener as set forth in claim 7, wherein said electric motor and geartrain assembly includes a secondary housing mounted within said main housing, and wherein said electric motor is sealed within said secondary housing.

10. The powered garage door opener as set forth in claim 1, wherein a gear ratio associated with said reduction gearset allows said electric motor to be back-driven for permitting manual actuation of the garage door.

11. The powered garage door opener as set forth in claim 1 wherein said garage door opener is non-handed such that it may be slidingly installed from either end of the garage door shaft.

12. The powered garage door opener as set forth in claim 11, wherein a pair of said non-handed garage door openers may be installed side-by-side on one end the garage door shaft or disposed on opposite ends of the garage door shaft, and wherein said control modules of said respective pair of non-handed garage door openers may be simultaneously controlled by a control signal.

13. The powered garage door opener as set forth in claim 1, wherein a pulley spooling a cable is mounted to the garage door shaft adjacent to said garage door opener, and wherein a two-piece pulley guard assembly is installed to surround a portion of said pulley to inhibit de-spooling of said cable when tension is reduced on said cable.

14. A garage door assembly having a powered garage door opener for operating a garage door between an open position and a closed position, comprising:
a garage door shaft extending between a first end shaft segment and a second end shaft segment;
at least one pulley mounted to said shaft and wherein a cable wound on said pulley connects said garage door shaft to said garage door such that rotation of said garage door shaft results in movement of said garage door; and
at least one garage door opener having an electric motor and geartrain assembly, wherein said electric motor and geartrain assembly includes a pass-thru output member defining a drive aperture extending therethrough and which is adapted to be coupled to said garage door shaft to drive said garage door between its open and closed positions, and wherein said pass-thru output member is driven by said electric motor and geartrain assembly for rotating said pass-thru output member to provide power actuation of said garage door.

15. The garage door assembly as set forth in claim 14, wherein said at least one garage door opener includes a first garage door opener and a second garage door opener.

16. The garage door assembly as set forth in claim 15, wherein said first garage door opener is coupled to said first end shaft segment and said second garage door opener is coupled to said second end shaft segment.

17. The garage door assembly as set forth in claim 15, wherein said first and second garage door openers are coupled to said first end shaft segment or said second end shaft segment.

18. The garage door assembly as set forth in claim 14, further including a two-piece pulley guard assembly installed to surround a portion of said at least one pulley to inhibit de-spooling of said cable when tension on said cable is reduced.

19. The garage door assembly as set forth in claim 18, wherein said two-piece pulley guard includes an upper guard segment and a lower guard segment interconnected with at least one mounting fastener.

20. The garage door assembly as set forth in claim 19, wherein said two-piece pulley guard includes a mounting bracket attached to a garage wall, and wherein said upper guard segment includes a bracket retainer slideable along said mounting bracket to provide position adjustment relative to the garage wall.
